(19) United States
(12) Patent Application Publication
(10) Pub. No.: US 2018/0029072 A1
(43) Pub. Date: Feb. 1, 2018

(54) METHODS OF FABRICATING QUANTUM DOT COLOR FILM SUBSTRATES

(71) Applicant: Shenzhen China Star Optoelectronics Technology Co., Ltd., Shenzhen City (CN)

(72) Inventor: Ji Li, Shenzhen City (CN)

(21) Appl. No.: 14/908,117

(22) PCT Filed: Dec. 29, 2015
(86) PCT No.: PCT/CN2015/099622

§ 371 Date: Jan. 27, 2016

(30) Foreign Application Priority Data
Dec. 4, 2015 (CN) 201510884925.1

(51) Int. Cl. B05D 5/06; G02B 5/22; G02B 1/10

(52) U.S. Cl. CPC B05D 5/06; G02B 1/10; G02B 5/22; B82Y 20/00

(57) ABSTRACT

The present application provides a method of fabricating a quantum dot color film substrate, by utilizing a characteristic that a dispersion including dye molecules, quantum dots and polymers in which difference of surface free energy of the dye molecules and the quantum dots cause phase separation of the quantum dots and the dye molecules during a solvent evaporation process, red and green quantum dot light filter films of bilayer structure of quantum-dye molecule phase separation are formed, the red and the green quantum dot light filter films respectively have the red and the green quantum dots in the upper layers, and the red and the green dye molecules in the lower layers, so as to have effects of bilayer films structure of the quantum dot film added with the light filter film, in comparison to the bilayer films structure of the quantum dot film added with the light filter film, the bilayer structure of the red and the green quantum dot light filter films do not have interface effect that the interface effect causing light loss is reduced; simultaneously, for completing the phase separation only requires the solvent evaporation process, the fabrication process is simpler than the conventional bilayer films structure of the quantum dot film added with the light filter film.

### FIELD OF THE INVENTION

The present application relates to display technical field, specifically to a method of fabricating a quantum dot color film substrate.

### BACKGROUND OF THE INVENTION

With continuous development of display technology, people require higher and higher display quality of display devices. Materials of Quantum dots (so called QDs) refer to semiconductor crystal grains of particle size in 1-100 nm. Due to smaller particle sizes of QDs that are smaller than or close to exciton Bohr radius of corresponding host materials, QDs generate quantum confinement effect, continuous energy band structure of the host materials is changed as discrete energy level structure in which electrons occur transition to emit fluorescence under excitation of external light source.

Such special discrete energy level structure of QDs allow narrow half-wave width thereof, so that monochromatic light of higher purity can be emitted, and higher luminous efficiency compared to conventional display instruments can be obtained. At the same time, due to energy level bandgap of QDs more influenced by sizes thereof, light of various wavelengths can emit by adjusting sizes of QDs or using QDs of different composition to be excited. Introducing QDs to replace conventional color photoresist on the color film substrate can greatly increase color gamut and transmittance of TFT-LCD to bring better display effect.

Currently, application of QDs in flat panel displays mainly uses QDs capable of emitting light of narrow wavelength (small half-peak) and bright color under specific backlight excitation in order to achieve an object that the display devices can display wider color gamut. Now, the most common approach is that a red quantum dot layer containing red QDs (R-QDs) and a green quantum dot layer containing green QDs (G-QDs) are respectively applied to red (R) and (G) pixels with blue light LED as the backlight, and a blue (B) pixel is provided by the backlight. When the blue backlight excites R-QDs or G-QDs, the blue backlight is only partially absorbed than converted to red or green. At this time, appeared light through the quantum dot layer in fact is a mixed light of blue and red, or blue and green; that is, light from the red quantum dot layer is magenta, and light from the green quantum dot layer is cyan (blue-green). Therefore, for obtaining purer red and green monochromatic light, usually, after a color filter layer or a quantum dot layer is formed, another color filter layer or another quantum dot layer is further coated thereon to allow the light pass through the red quantum dot layer or the green quantum dot layer, then pass through a red color filter (R-color filter) and a green color filter (G-color filter), and the purer red and green light are thus obtained.

However, such method has following drawbacks: 1, it is a complex fabrication that the quantum dot layer and the color filter layer need two processes; 2, due to presence of an interface between the layer and layer, refraction and scattering of the light are increased and not favorable to the use of the light, and the refraction and scattering of the light also have adverse effects on display contrast.

### SUMMARY OF THE INVENTION

An aspect of the present application is to provide a method of fabricating a quantum dot color film substrate, by utilizing a characteristic that dye molecules and quantum dots in the dispersion occur phase separation during a solvent evaporation process, so as to form a quantum dot light filter film of bilayer structure of quantum-dye molecule phase separation, the bilayer structure of the obtained quantum dot light filter film does not have interface effect that the interface effect causing light loss is reduced, and the fabrication process is simple.

For achieving the above aspect, the present application provides a method of fabricating a quantum dot color film substrate, including steps as follows:

step 1, providing an underlay substrate, forming a black matrix on the underlay substrate, wherein the black matrix encloses the underlay substrate to form red sub pixel regions, green sub pixel regions and blue sub pixel regions;

step 2, providing a first dispersion and a second dispersion, wherein the first dispersion includes red quantum dots, red dye molecules and a solvent, the second dispersion includes green quantum dots, green dye molecules and a solvent;

step 3, respectively coating the first dispersion and the second dispersion in the red sub pixel regions and the green sub pixel regions on the underlay substrate, heating the first dispersion and the second dispersion to evaporate the solvents in the first dispersion and the second dispersion, during the evaporation of the solvents, the red quantum dots in the first dispersion and the green quantum dots in the second dispersion tending to aggregate in upper layer, and the red dye molecules and the green dye molecules tending to aggregate in lower layer, so as to form a thin film of bilayer structure of quantum dot-dye molecule phase separation;

step 4, drying the thin film till complete dryness to obtain red quantum dot light filter films and green quantum dot light filter films respectively located in the red sub pixel regions and the green sub pixel regions on the underlay substrate, wherein the red quantum dot light filter films and the green quantum dot light filter films have the bilayer structure, which respectively have the red quantum dots and the green quantum dots in the upper layer, and the red dye molecules and the green dye molecules in the lower layer, so as to obtain a color film layer including the red quantum dot light filter films and the green quantum dot light filter films; and

step 5, forming an electrode layer, an alignment film layer to complete the fabrication of the quantum dot color film substrate.

In step 1, a thickness of the black matrix formed on the underlay substrate is 1-3 μm.

Particle sizes of the red quantum dots and the green quantum dots are 3-10 nm, the red quantum dots and the green quantum dots respectively emit red light and green light under light excitation, the red quantum dots and the green quantum dots include one or more than one of PbSe quantum dot, CdSe quantum dot, (CdSe)ZnS quantum dot, (CuInS2)ZnS quantum dot and Au quantum dot;

respective concentrations of the red quantum dots and the green quantum dots in the first dispersion and the second dispersion are 0.5-10 mg/mL.

The red quantum dots and the green quantum dots have a layer of modification molecules for packing and modifying surfaces thereof, the modification molecules are octadecenoic acid, pyrimidine, trioctyl phosphine oxide or dodecyl mercaptan.

The red dye molecules and the green dye molecules are dyes of azo, anthraquinone, xanthene, dioxazine or triphenylmethane;

respective concentrations of the red dye molecules and the green dye molecules in the first dispersion and the second dispersion are 0.1-10 mg/mL

Polymers in the first dispersion and the second dispersion are polymethyl acrylate, polyethyl acrylate, polybutyl acrylate, polystyrene, polycarbonate, polyN,N′-diphenyl-N,N′-di(3-methylphenyl)-1,1′-biphenyl-4,4′-diamine or poly4,4′-bis[N-(1-naphthyl)-N-phenylamino]biphenyl;

amounts of the polymers contained in the first dispersion and the second dispersion are 0.1-10 wt %.

The solvents in the first dispersion and the second dispersion are chloroform, chlorobenzene, acetone, toluene, hexane, pyridine, N,N-dimethylacetamide, N,N-dimethylformamide or tetrahydrofuran.

In step 3, the method of coating the first dispersion and the second dispersion is spin coating, slit dispensing or ink jet printing.

In step 3, the temperature of heating is 90-180° C., the time of heating is 2-15 min.

Step 4 further includes forming a protection layer on the color film layer, a material of the protection layer is silicon nitride, silicon oxide or organic transparent material.

The present application further provides a method of fabricating a quantum dot color film substrate, including steps as follows:

step 1, providing an underlay substrate, forming a black matrix on the underlay substrate, wherein the black matrix encloses the underlay substrate to form red sub pixel regions, green sub pixel regions and blue sub pixel regions;

step 2, providing a first dispersion and a second dispersion, wherein the first dispersion includes red quantum dots, red dye molecules and a solvent, the second dispersion includes green quantum dots, green dye molecules and a solvent;

step 3, respectively coating the first dispersion and the second dispersion in the red sub pixel regions and the green sub pixel regions on the underlay substrate, heating the first dispersion and the second dispersion to evaporate the solvents in the first dispersion and the second dispersion, during the evaporation of the solvents, the red quantum dots in the first dispersion and the green quantum dots in the second dispersion tending to aggregate in upper layer, and the red dye molecules and the green dye molecules tending to aggregate in lower layer, so as to form a thin film of bilayer structure of quantum dot-dye molecule phase separation;

step 4, drying the thin film till complete dryness to obtain red quantum dot light filter films and green quantum dot light filter films respectively located in the red sub pixel regions and the green sub pixel regions on the underlay substrate, wherein the red quantum dot light filter films and the green quantum dot light filter films have the bilayer structure, which respectively have the red quantum dots and the green quantum dots in the upper layer, and the red dye molecules and the green dye molecules in the lower layer, so as to obtain a color film layer including the red quantum dot light filter films and the green quantum dot light filter films; and

step 5, forming an electrode layer, an alignment film layer to complete the fabrication of the quantum dot color film substrate;

wherein, in step 1, a thickness of the black matrix formed on the underlay substrate is 1-3 μm;

wherein, in step 3, the method of coating the first dispersion and the second dispersion is spin coating, slit dispensing or ink jet printing;

wherein, in step 3, the temperature of heating is 90-180° C., the time of heating is 2-15 min;

wherein step 4 further includes forming a protection layer on the color film layer, a material of the protection layer is silicon nitride, silicon oxide or organic transparent material.

Advantages of the present application are that the present application provides a method of fabricating a quantum dot color film substrate, by utilizing a characteristic that a dispersion including dye molecules, quantum dots and polymers in which difference of surface free energy of the dye molecules and the quantum dots cause phase separation of the quantum dots and the dye molecules during a solvent evaporation process, red quantum dot light filter film and green quantum dot light filter film of bilayer structure of quantum-dye molecule phase separation are formed, the red quantum dot light filter film and the green quantum dot light filter film respectively have the red quantum dots and the green quantum dots in the upper layers, and the red dye molecules and the green dye molecules in the lower layers, so as to have effects of bilayer films structure of the quantum dot film added with the light filter film, in comparison to the bilayer films structure of the quantum dot film added with the light filter film, the bilayer structure of the red quantum dot light filter film and the green quantum dot light filter film do not have interface effect that the interface effect causing light loss is reduced; simultaneously, for completing the phase separation only requires the solvent evaporation process, the fabrication process is simpler than the conventional bilayer films structure of the quantum dot film added with the light filter film.

### BRIEF DESCRIPTION OF THE DRAWINGS

The technical features and advantages of the present application will become more readily apparent through the detailed description of embodiments and following accompanying drawings, in which:

FIG. 1 is a schematic flow chart illustrating a method of fabricating a quantum dot color film substrate of the present application;

FIG. 2 is a schematic diagram illustrating step 1 of the method of fabricating the quantum dot color film substrate of the present application;

FIG. 3 is a schematic diagram illustrating coating a dispersion on a underlay substrate in step 3 of the method of fabricating the quantum dot color film substrate of the present application;

FIG. 4 is a schematic diagram illustrating quantum dots and dye molecules in the dispersion occurring phase separation in step 3 of the method of fabricating the quantum dot color film substrate of the present application;

FIG. 5 is a schematic diagram illustrating forming a color film layer in step 4 of the method of fabricating the quantum dot color film substrate of the present application;

FIG. 6 is a schematic diagram illustrating forming a protection layer on the color film layer in step 4 of the method of fabricating the quantum dot color film substrate of the present application;

FIG. 7 is a schematic diagram illustrating forming an electrode layer and an alignment layer on the protection layer in step 5 of the method of fabricating the quantum dot color film substrate of the present application; and

FIG. 8 is a schematic diagram illustrating the quantum dot color film substrate, fabricated by the present application, for use in a display device to perform color display.

### DETAILED DESCRIPTION OF PREFERRED EMBODIMENTS

For further illustrating the techniques and effects adopted by the present application, the preferable embodiments of the present application and accompanying drawings will be described in more detail as follows.

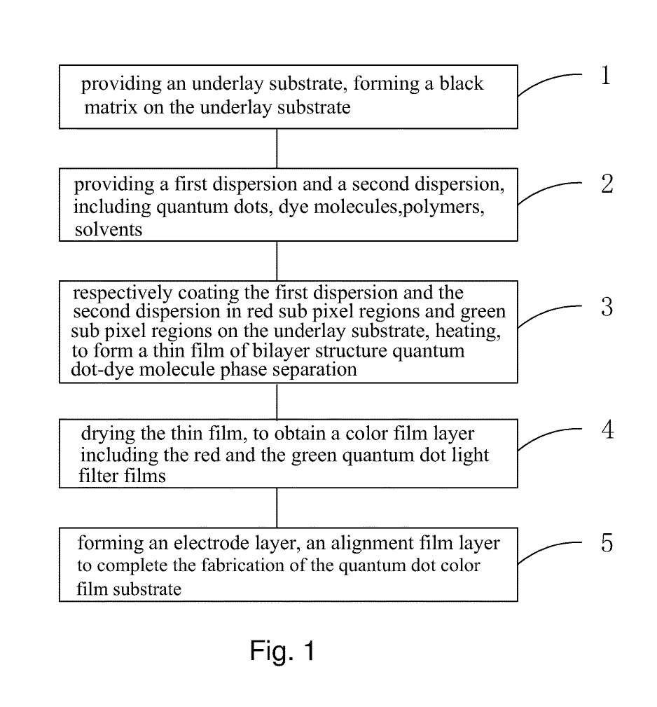

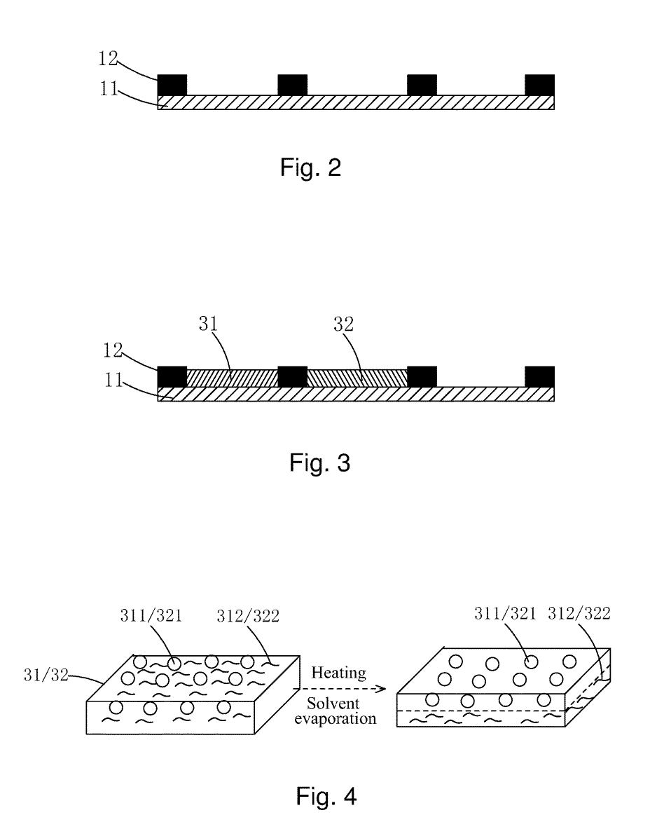

Please refer to FIG. 1, the present application provides a method of fabricating a quantum dot color film substrate including steps as follows:

step 1, as shown in FIG. 1, providing an underlay substrate 11, forming a black matrix 12 on the underlay substrate 11, wherein the black matrix 12 encloses the underlay substrate 11 to form red sub pixel regions, green sub pixel regions and blue sub pixel regions;

specifically, a thickness of the black matrix 12 formed on the underlay substrate 11 is 1-3 μm; the black matrix 12 is used for shielding light to prevent color mixing between different pixels, and also as a barrier wall.

Step 2, providing a first dispersion 31 and a second dispersion 32, wherein the first dispersion 31 includes red quantum dots 311, red dye molecules 312, polymers and a solvent, the second dispersion 32 includes green quantum dots 321, green dye molecules 322, polymer and a solvent;

specifically, particle sizes of the red quantum dots 311 and the green quantum dots 321 are 3-10 nm, the sizes thereof are selected according to the desired color, the red quantum dots 311 and the green quantum dots 321 respectively emit red light and green light under light excitation, the red quantum dots 311 and the green quantum dots 321 include one or more than one of PbSe quantum dot, CdSe quantum dot, (CdSe)ZnS quantum dot, (CuInS2)ZnS quantum dot and Au quantum dot; specifically, respective concentrations of the red quantum dots and the green quantum dots in the first dispersion and the second dispersion are 0.5-10 mg/mL

Specifically, the red quantum dots 311 and the green quantum dots 321 have a layer of modification molecules for packing and modifying surfaces thereof, the modification molecules are molecule materials of octadecenoic acid, pyrimidine, trioctyl phosphine oxide, or dodecyl mercaptan, etc.

Specifically, the red dye molecules 312 and the green dye molecules 322 are dyes of azo, anthraquinone, xanthene, dioxazine or triphenylmethane; respective concentrations of the red dye molecules 312 and the green dye molecules 322 in the first dispersion 31 and the second dispersion 32 are 0.1-10 mg/mL.

Specifically, the polymers in the first dispersion 31 and the second dispersion 32 are polymer materials of polymethyl acrylate, polyethyl acrylate, polybutyl acrylate, polystyrene, polycarbonate, polyN,N′-diphenyl-N,N′-di(3-methylphenyl)-1,1′-biphenyl-4,4′-diamine or poly4,4′-bis[N-(1-naphthyl)-N-phenylamino]biphenyl, etc.; amounts of the polymers contained in the first dispersion 31 and the second dispersion 32 are 0.1-10 wt %.

Specifically, the solvents in the first dispersion 31 and the second dispersion 32 are solvents of chloroform, chlorobenzene, acetone, toluene, hexane, pyridine, N,N-dimethylacetamide, N,N-dimethylformamide or tetrahydrofuran, etc.

Step 3, as shown in FIG. 3, respectively coating the first dispersion 31 and the second dispersion 32 in the red sub pixel regions and green sub pixel regions on the underlay substrate 11, heating the first dispersion 31 and the second dispersion 32 at a temperature in 90-180° C. for 2-15 min to evaporate the solvents in the first dispersion 31 and the second dispersion 32, during the evaporation of the solvents, the red quantum dots 311 in the first dispersion 31 and the green quantum dots 321 in the second dispersion 32 tending to aggregate in upper layer, and the red dye molecules 312 and the green dye molecules 322 tending to aggregate in lower layer, so as to form a thin film of bilayer structure of quantum dot-dye molecule phase separation;

specifically, the method of coating the first dispersion 31 and the second dispersion 32 is spin coating, slit dispensing or ink jet printing.

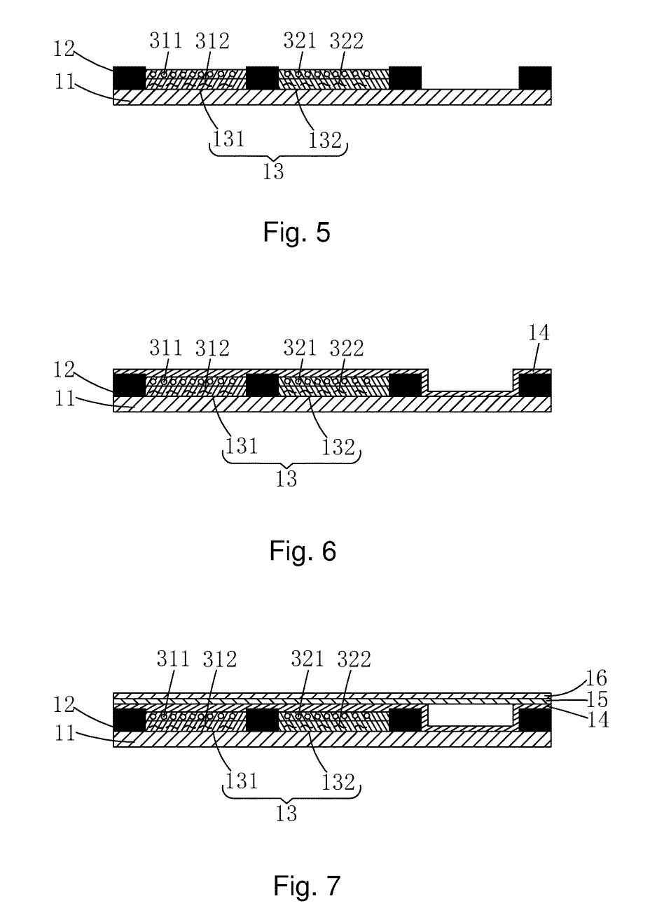

Step 4, as shown in FIG. 5, drying the thin film till complete dryness to obtain red quantum dot light filter films 131 and green quantum dot light filter films 132 respectively located in the red sub pixel regions and the green sub pixel regions on the underlay substrate 11, wherein the red quantum dot light filter films 131 and the green quantum dot light filter films 132 have the bilayer structure, which respectively have the red quantum dots 311 and the green quantum dots 321 in the upper layer, and the red dye molecules 312 and the green dye molecules 322 in the lower layer, so as to obtain a color film layer 13 including the red quantum dot light filter films 131 and the green quantum dot light filter films 132.

As shown in FIG. 6, step 4 further includes forming a protection layer 14 on the color film layer 13 to prevent the solvents damage the color film layer 13 in following fabrication process, a material of the protection layer 14 is silicon nitride, silicon oxide or organic transparent material.

Step 5, as shown in FIG. 7, forming an electrode layer and an alignment film layer through current ITO fabrication process and PI fabrication process, so as to complete the fabrication of the quantum dot color film substrate.

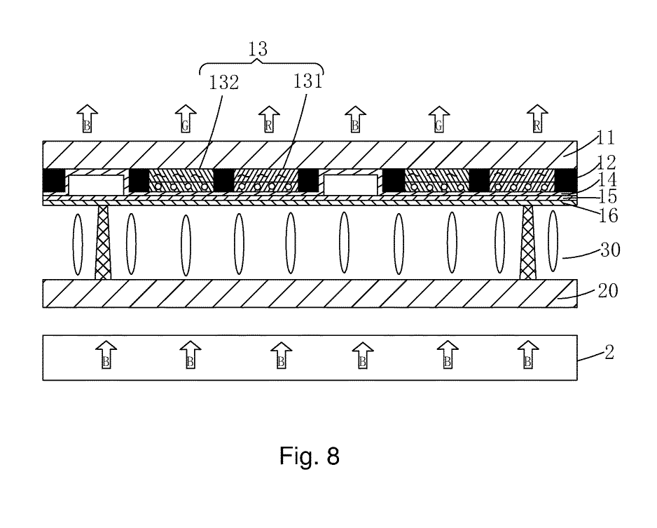

Specifically, as shown in FIG. 8, the quantum dot color film substrate obtained by the present application is used in a display device which has blue backlight. The backlight module 2 emits blue backlight, the blue backlight irradiates on the quantum dot color film substrate through an array substrate 20 and liquid crystal layer 30. The red quantum dots 311 in the red quantum dot light filter films 131 emit red light of very narrow full width at half maximum under blue backlight excitation, and the red light mix the unabsorbed blue backlight to form mixed light, soon after, the mixed light pass through the layer of red dye molecules 312 contained in the red quantum dot light filter film 131 to be filtered as red monochromatic light of high purity, then display red color; similarly, the blue backlight pass through the green quantum dot light filter film 132 to emit green monochromatic light, then display green color; due that positions corresponding to the blue sub pixel regions are not covered by the quantum dot light filter film, the blue backlight directly pass through the positions, then display blue color; finally, the red, green and blue trichromatic desired for color display are provided, so that the color display is achieved, and display gamut index can be effectively enhanced.

In summary, the present application provides a method of fabricating a quantum dot color film substrate, by utilizing a characteristic that a dispersion including dye molecules, quantum dots and polymers in which difference of surface free energy of the dye molecules and the quantum dots cause phase separation of the quantum dots and the dye molecules during a solvent evaporation process, red quantum dot light filter film and green quantum dot light filter film of bilayer structure of quantum-dye molecule phase separation are formed, the red quantum dot light filter film and the green quantum dot light filter film respectively have the red quantum dots and the green quantum dots in the upper layers, and the red dye molecules and the green dye molecules in the lower layers, so as to have effects of bilayer films structure of the quantum dot film added with the light filter film, in comparison to the bilayer films structure of the quantum dot film added with the light filter film, the bilayer structure of the red quantum dot light filter film and the green quantum dot light filter film do not have interface effect that the interface effect causing light loss is reduced; simultaneously, for completing the phase separation only requires the solvent evaporation process, the fabrication process is simpler than the conventional bilayer films structure of the quantum dot film added with the light filter film.

To those ordinarily skilled in the art, the above description is intended to cover various modifications and similar arrangements according to the technical solution and spirit of the present application, and the various modifications and similar arrangements are included within the spirit and scope of the appended claims of the present application.

What is claimed is:

1. A method of fabricating a quantum dot color film substrate, comprising steps as follows:
step 1, providing an underlay substrate, forming a black matrix on the underlay substrate, wherein the black matrix encloses the underlay substrate to form red sub pixel regions, green sub pixel regions and blue sub pixel regions;
step 2, providing a first dispersion and a second dispersion, wherein the first dispersion comprises red quantum dots, red dye molecules and a solvent, the second dispersion comprises green quantum dots, green dye molecules and a solvent;
step 3, respectively coating the first dispersion and the second dispersion in the red sub pixel regions and the green sub pixel regions on the underlay substrate, heating the first dispersion and the second dispersion to evaporate the solvents in the first dispersion and the second dispersion, during the evaporation of the solvents, the red quantum dots in the first dispersion and the green quantum dots in the second dispersion tending to aggregate in upper layer, and the red dye molecules and the green dye molecules tending to aggregate in lower layer, so as to form a thin film of bilayer structure of quantum dot-dye molecule phase separation;
step 4, drying the thin film till complete dryness to obtain red quantum dot light filter films and green quantum dot light filter films respectively located in the red sub pixel regions and the green sub pixel regions on the underlay substrate, wherein the red quantum dot light filter films and the green quantum dot light filter films have the bilayer structure, which respectively have the red quantum dots and the green quantum dots in the upper layer, and the red dye molecules and the green dye molecules in the lower layer, so as to obtain a color film layer comprising the red quantum dot light filter films and the green quantum dot light filter films; and
step 5, forming an electrode layer, an alignment film layer to complete the fabrication of the quantum dot color film substrate.

2. The method of fabricating the quantum dot color film substrate according to claim 1, wherein, in step 1, a thickness of the black matrix formed on the underlay substrate is 1-3 μm.

3. The method of fabricating the quantum dot color film substrate according to claim 1, wherein particle sizes of the red quantum dots and the green quantum dots are 3-10 nm, the red quantum dots and the green quantum dots respectively emit red light and green light under light excitation, the red quantum dots and the green quantum dots comprise one or more than one of PbSe quantum dot, CdSe quantum dot, (CdSe)ZnS quantum dot, (CuInS2)ZnS quantum dot and Au quantum dot;
respective concentrations of the red quantum dots and the green quantum dots in the first dispersion and the second dispersion are 0.5-10 mg/mL

4. The method of fabricating the quantum dot color film substrate according to claim 3, wherein the red quantum dots and the green quantum dots have a layer of modification molecules for packing and modifying surfaces thereof, the modification molecules are octadecenoic acid, pyrimidine, trioctyl phosphine oxide or dodecyl mercaptan.

5. The method of fabricating the quantum dot color film substrate according to claim 1, wherein the red dye molecules and the green dye molecules are dyes of azo, anthraquinone, xanthene, dioxazine or triphenylmethane;
respective concentrations of the red dye molecules and the green dye molecules in the first dispersion and the second dispersion are 0.1-10 mg/mL

6. The method of fabricating the quantum dot color film substrate according to claim 1, wherein polymers in the first dispersion and the second dispersion are polymethyl acrylate, polyethyl acrylate, polybutyl acrylate, polystyrene, polycarbonate, polyN,N′-diphenyl-N,N′-di(3-methylphenyl)-1,1′-biphenyl-4,4′-diamine or poly4,4′-bis[N-(1-naphthyl)-N-phenylamino]biphenyl;
amounts of the polymers contained in the first dispersion and the second dispersion are 0.1-10 wt %.

7. The method of fabricating the quantum dot color film substrate according to claim 1, wherein the solvents in the first dispersion and the second dispersion are chloroform, chlorobenzene, acetone, toluene, hexane, pyridine, N,N-dimethylacetamide, N,N-dimethylformamide or tetrahydrofuran.

8. The method of fabricating the quantum dot color film substrate according to claim 1, wherein, in step 3, the method of coating the first dispersion and the second dispersion is spin coating, slit dispensing or ink jet printing.

9. The method of fabricating the quantum dot color film substrate according to claim 1, wherein, in step 3, the temperature of heating is 90-180° C., the time of heating is 2-15 min.

10. The method of fabricating the quantum dot color film substrate according to claim 1, wherein step 4 further comprises forming a protection layer on the color film layer, a material of the protection layer is silicon nitride, silicon oxide or organic transparent material.

11. A method of fabricating a quantum dot color film substrate, comprising steps as follows:
step 1, providing an underlay substrate, forming a black matrix on the underlay substrate, wherein the black matrix encloses the underlay substrate to form red sub pixel regions, green sub pixel regions and blue sub pixel regions;
step 2, providing a first dispersion and a second dispersion, wherein the first dispersion comprises red quantum dots, red dye molecules and a solvent, the second dispersion comprises green quantum dots, green dye molecules and a solvent;
step 3, respectively coating the first dispersion and the second dispersion in the red sub pixel regions and the green sub pixel regions on the underlay substrate, heating the first dispersion and the second dispersion to evaporate the solvents in the first dispersion and the second dispersion, during the evaporation of the solvents, the red quantum dots in the first dispersion and the green quantum dots in the second dispersion tending to aggregate in upper layer, and the red dye molecules and the green dye molecules tending to aggregate in lower layer, so as to form a thin film of bilayer structure quantum dot-dye molecule phase separation;
step 4, drying the thin film till complete dryness to obtain red quantum dot light filter films and green quantum dot light filter films respectively located in the red sub pixel regions and the green sub pixel regions on the underlay substrate, wherein the red quantum dot light filter films and the green quantum dot light filter films have the bilayer structure, which respectively have the red quantum dots and the green quantum dots in the upper layer, and the red dye molecules and the green dye molecules in the lower layer, so as to obtain a color film layer comprising the red quantum dot light filter films and the green quantum dot light filter films; and
step 5, forming an electrode layer, an alignment film layer to complete the fabrication of the quantum dot color film substrate;
wherein, in step 1, a thickness of the black matrix formed on the underlay substrate is 1-3 μm;
wherein, in step 3, the method of coating the first dispersion and the second dispersion is spin coating, slit dispensing or ink jet printing;
wherein, in step 3, the temperature of heating is 90-180° C., the time of heating is 2-15 min;
wherein step 4 further comprises forming a protection layer on the color film layer, a material of the protection layer is silicon nitride, silicon oxide or organic transparent material.

12. The method of fabricating the quantum dot color film substrate according to claim 11, wherein particle sizes of the red quantum dots and the green quantum dots are 3-10 nm, the red quantum dots and the green quantum dots respectively emit red light and green light under light excitation, the red quantum dots and the green quantum dots comprise one or more than one of PbSe quantum dot, CdSe quantum dot, (CdSe)ZnS quantum dot, (CuInS2)ZnS quantum dot and Au quantum dot;
respective concentrations of the red quantum dots and the green quantum dots in the first dispersion and the second dispersion are 0.5-10 mg/mL

13. The method of fabricating the quantum dot color film substrate according to claim 12, wherein the red quantum dots and the green quantum dots have a layer of modification molecules for packing and modifying surfaces thereof, the modification molecules are octadecenoic acid, pyrimidine, trioctyl phosphine oxide or dodecyl mercaptan.

14. The method of fabricating the quantum dot color film substrate according to claim 11, wherein the red dye molecules and the green dye molecules are dyes of azo, anthraquinone, xanthene, dioxazine or triphenylmethane;
respective concentrations of the red dye molecules and the green dye molecules in the first dispersion and the second dispersion are 0.1-10 mg/mL

15. The method of fabricating the quantum dot color film substrate according to claim 11, wherein polymers in the first dispersion and the second dispersion are polymethyl acrylate, polyethyl acrylate, polybutyl acrylate, polystyrene, polycarbonate, polyN,N′-diphenyl-N,N′-di(3-methylphenyl)-1,1′-biphenyl-4,4′-diamine or poly4,4′-bis[N-(1-naphthyl)-N-phenylamino]biphenyl;
amounts of the polymers contained in the first dispersion and the second dispersion are 0.1-10 wt %.

16. The method of fabricating the quantum dot color film substrate according to claim 11, wherein the solvents in the first dispersion and the second dispersion are chloroform, chlorobenzene, acetone, toluene, hexane, pyridine, N,N-dimethylacetamide, N,N-dimethylformamide or tetrahydrofuran.
